(19) United States
(12) Patent Application Publication
(10) Pub. No.: US 2010/0214404 A1
(43) Pub. Date: Aug. 26, 2010

(54) FLUORESCENCE FOCAL MODULATION MICROSCOPY SYSTEM AND METHOD

(76) Inventors: Nanguang Chen, Singapore (SG); Colin Sheppard, Singapore (SG); Chee Howe Wong, Singapore (SG)

Correspondence Address: OSTROLENK FABER GERB & SOFFEN, 1180 AVENUE OF THE AMERICAS, NEW YORK, NY, 100368403, US

(21) Appl. No.: 12/667,782

(22) PCT Filed: Jul. 7, 2008
(86) PCT No.: PCT/SG08/00240

§ 371 Date: Jan. 5, 2010

Related U.S. Application Data
(60) Provisional application No. 60/948,280, filed on Jul. 6, 2007.

(51) Int. Cl. G02B 21/36; G02B 21/06; G02B 26/06; G02B 26/10; H04N 7/18

(52) U.S. Cl. 348/79; 359/385; 359/290; 359/204.2; 348/E07.085

(57) ABSTRACT

A fluorescence focal modulation microscopy system and method is disclosed for high resolution molecular imaging of thick biological tissues with single photon excited fluorescence. Optical sectioning and diffraction limited spatial resolution are retained for imaging inside a multiple-scattering medium by the use of focal modulation, a technique for suppressing the background fluorescence signal excited by the scattered light. The focal modulation microscopy system has a spatial phase modulator inserted in the excitation light path, which varies the spatial distribution of coherent excitation light around the focal volume periodically at a preset frequency. A fluorescence focal modulation image is formed on a display with the demodulated fluorescence, while a confocal image is available simultaneously.

### FIELD OF THE INVENTION

This invention relates generally to optical microscopes and more particularly to fluorescence and confocal optical microscope systems and methods.

### BACKGROUND

Various optical microscopes have been developed and used in modern biological research and clinical diagnosis. They are frequently needed to observe cells and their subcellular structures. The initial discovery of cells more than 300 years ago, which was the origin of modern cell biology, was the direct result of the invention of microscope. Classical light microscopes have very limited imaging depth. Only superficial microscopic structures can be observed or the sample needs to be mechanically sectioned into very thin slices. The invention of confocal microscopy as described in U.S. Pat. No. 3,013,467 led to a leap in the imaging depth as a result of optical sectioning capability. A penetration depth up to 200 microns can be achieved with biological tissues. Confocal microscopes generally work with fluorescent dyes to provide molecular sensitivity and specificity. By the use of multi-photon excitation of fluorescent molecules, the imaging depth can be further improved to around 700 microns. However, a multi-photon microscope requires the use of an expensive pulsed laser. In addition, the pulsed laser output may cause nonlinear photo-induced damage to living cells, which is especially not desirable for applications to human subjects.

Biological tissues are heterogeneous from microscopic to macroscopic scales. Generally they appear opaque to visible and near infrared light as photons are subject to strong scattering and absorption. Scattering, especially multiple scattering, is an undesirable phenomenon in imaging science that alters the propagation direction of photons. The main problem preventing confocal microscopes from seeing deeper inside biological tissue is multiple scattering. Fluorescence emission from out of focus regions, which may diffuse into the focal volume, cannot be sufficiently rejected by the confocal pinhole, and thus contribute to the background signal. The signal to background ratio and spatial resolution deteriorate rapidly with increasing depth. The scattering mean free path Iₛ, the average distance between consecutive scattering events, has a typical value around 100 microns in human soft tissues. While conventional wide field microscopy can only deal with very thin samples, the invention of confocal microscopy was a significant advance in modern light microscopy as optical sectioning capability is provided. In a confocal microscope, the sample is illuminated by a focused beam and scanned point-by-point, and the detection system is focused to the same region in the specimen by the use of a confocal pinhole. In an ideal situation, out-of-focus light from the sample is mostly rejected while the signal from the focal point is collected. However, this selective detection scheme is not so effective when the focal point moves into the sample for such a depth that the scattered photons dominate the ballistic ones. The point spread function, which determines the spatial resolution, is broadened rapidly in space with increasing imaging depth. Although a strong target might be detectable at depths over a few Iₛ, high resolution details can be easily masked by background signal even when the target is located at only one Iₛ from the surface. Subcellular imaging with a confocal microscope is usually performed at a maximum imaging depth of a few tens of microns.

In multi-photon microscopy, the focused illumination beam is further concentrated within an ultra short time window of less than one picosecond. The nonlinear absorption rate decays sharply out of focus and this selective excitation method is effective when the imaging depth is less than 1 mm. Multi-photon microscopy has become an increasingly popular alternative to confocal microscopy as a result of improved imaging depth and localized photochemistry. However, multi-photon microscopy is a very expensive technique that uses laser sources of ultra short pulses. In addition, single photon excitation is preferred over multi-photon excitation in some situations in which nonlinear photo-damage, availability of fluorescence probes, tissue autofluorescence background, and image acquisition speed are of concern.

Optical coherence tomography is a relatively new imaging technique that is capable of providing high resolution structural images. Coherence gating is used to resolve signals from different depth. The contribution from multiple-scattering photons is heavily suppressed because their coherence property is lost after scattering. An imaging depth of a few millimeters can be readily achieved with this technique. Applications of this technique in retinal and anterior segment imaging have been commercialized. Active investigation is underway for this technique for potential applications in tissue engineered product characterization, blood vessel evaluation, skin cancer diagnosis, and cancer detection for the gastrointestinal (GI) track. Unfortunately, the contrast mechanism of optical coherence tomography is based on back scattering and is not compatible with fluorescence. Many research groups have been trying to attach other molecular specific techniques, such as absorption and second harmonic generation, to optical coherence tomography. However, the spatial resolution is usually severely compromised with these combinations, besides other limitations. The coherence gating mechanism in optical coherence tomography is very effective in picking up the desired signal. Although some of multiply scattered light still reaches the photodetector, only the back scattered, scattered once, or reflected light, which has a well defined optical pathlength and polarization state, generates the fringe signal for image formation. The imaging depth and speed have been further improved recently with the Fourier domain techniques. Unfortunately, optical coherence tomography is not compatible with fluorescence. While it has been successfully applied to in vivo visualization of the fine structures of human eyes and hollow organs, its molecular imaging capability is rather limited.

Therefore, there is a need for an optical microscope that addresses the limitations or at least alleviates the above discussed problems with conventional optical microscopes. In particular, there is a need to maintain a near-diffraction-limited resolution in a deeper region and develop a mechanism to effectively prevent the multiply scattered photons from being involved in image formation.

### SUMMARY

An aspect of the invention provides a fluorescence focal modulation microscopy system comprising a light source assembly for generating a light beam and illuminating a target region of a sample; a spatial phase modulator arranged in the path of the light beam and splitting the light beam into a first beam and a second beam, the first beam being parallel and spatially separated from to the second beam, the second beam modulated with a different phase delay from the first beam; a focusing assembly receiving the first beam and the second beam and illuminating the target region of the sample; and a photodetector assembly for receiving a luminescence signal emitted from the illuminated target region of the sample, and converting the luminescence signal detected by the photodetector to a photoelectrical signal having a DC component and an AC component.

In an embodiment the system further comprises a processor and a display, the processor processes an image on the display based on receiving the photoelectrical signal and calculating the maximum emission intensity from the sum of the AC amplitude of the AC component and the DC magnitude of the DC component, and/or the processor processes an image on the display based on receiving the photoelectrical signal and basing the image on the AC component of photoelectrical signal. The spatial phase modulator may comprise a wavelength scanning source and a differential delay line, and the wavelength scanning source may be arranged to repeatedly sweep the wavelength of the light source with a predetermined difference in the optical path. The spatial phase modulator may comprise a first mirror and a second mirror, the second mirror moveable relative to the first mirror to modulate the second beam relative to the first beam, wherein the second mirror may be mounted on a piezoelectric actuator and the relative phase shift between the first and second beam is dependent on a voltage applied to the piezoelectric actuator. The spatial phase modulator may be arranged along the path of the light beam generated from the source and the path of the luminescence emitted from the illuminated target region of the sample. The focusing assembly may comprise a dichroic mirror and an objective lens, and the spatial phase modulator may be arranged along in the path of the light beam upstream or downstream of the dichroic mirror. The system may further comprise a scanning assembly for scanning the first beam and second beam relative to the sample, where the scanning assembly may comprise a steering mirror for scanning the first beam and the second beam relative the sample, and/or the scanning assembly comprises a holder or moveable stage for holding the sample and an actuator for moveable scanning the sample relative the first light beam and the second light beam. The system may further comprise an aperture in the path of the luminescence signal emitted from the illuminated target region of the sample to prevent luminescence emitted from non-target region of the sample to reach the photodetector, where the aperture may be for example a pinhole, a slit, a long pass filter, an optical fibre cable or the like. The light source may be arranged for one photon excitation, multi-photon excitation, or the like. The photodetector assembly may further comprise a photomultiplier for converting the luminescence signal detected by the photodetector to the photoelectrical signal having a DC component and an AC component.

An aspect of the invention provides a method for performing fluorescence focal modulation microscopy comprising generating a light beam for illuminating a target region of a sample; splitting the light beam with a spatial phase modulator arranged in the path of the light beam into a first beam and a second beam, the first beam being parallel and spatially separated from to the second beam, the second beam modulated with a different phase delay from the first beam; focusing the first beam and second beam with a focusing assembly; illuminating the target region of the sample with the first beam and the second beam; receiving a luminescence signal emitted from the illuminated target region of the sample; and converting the luminescence signal detected by the photodetector to a photoelectrical signal having a DC component and an AC component.

In an embodiment the method further comprises processing an image on a display based on receiving the photoelectrical signal and calculating the maximum emission intensity from the sum of the AC amplitude of the AC component and the DC magnitude of the DC component, and/or processing an image on the display based on receiving the photoelectrical signal and basing the image on the AC component of photoelectrical signal. Splitting of the light beam may comprise splitting the light beam into a first beam and a second beam comprises repeatedly sweeping the wavelength of the light source with a predetermined difference in the optical path. The splitting the light beam into a first beam and a second beam may comprise the spatial phase modulator comprising a first mirror and a second mirror, and moving the second mirror relative to the first mirror to modulate the second beam relative to the first beam. The second mirror may be mounted on a piezoelectric actuator and generating the relative phase shift between the first and second beam by applying a voltage to the piezoelectric actuator. The method may further comprise scanning the first beam and the second beam relative the sample. The method may further comprise preventing luminescence emitted from non-target region of the sample to reach the photodetector by placing an aperture in the path of the luminescence signal emitted from the illuminated target region of the sample. The spatial phase modulator for splitting the light beam may be arranged along the path of the light beam generated from the source. The spatial phase modulator may also be arranged along the path of the luminescence emitted from the illuminated target region of the sample.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a schematic block diagram of a fluorescence focal modulation microscope with spatial phase modulation in accordance with an embodiment of the invention;

FIG. 2A-B show configurations of a spatial phase modulation in accordance with embodiments of the invention;

FIG. 3 is a schematic block diagram of a spatial phase modulator with a wavelength scanning source in accordance with an embodiment of the invention;

FIG. 4 is a schematic diagram of a spatial phase modulator in accordance with an embodiment of the invention;

FIG. 5 is a schematic block diagram of a fluorescence focal modulation microscope with spatial phase modulation in accordance with an embodiment of the invention;

FIG. 6A-C show a confocal microscopy image (FIG. 6A) and focal modulation microscopy image (FIG. 6B) of images of fluorescence microspheres and a graph of confocal microscopy and focal modulation microscopy signals as a function of defocus (FIG. 6C) in accordance with an embodiment of the invention;

FIG. 7A-D shows a confocal microscopy image (FIG. 7A) and focal modulation microscopy image (FIG. 7B) of images of chondrocytes at a depth of 400 microns, and respective higher magnifications (FIG. 7C-D) in accordance with an embodiment of the invention; and

FIG. 8 shows a flow chart of a method in accordance with an embodiment of the invention.

### DETAILED DESCRIPTION

A focal modulation microscopy system and method is disclosed. The technique in accordance with an embodiment of the invention targets an imaging depth comparable to optical coherence tomography combined with molecular specificity. By the use of a spatial phase modulator in the excitation light path, an intensity modulation is achieved mainly in the focal volume only, even when the focal point is located deep inside a turbid medium. The oscillatory component in the detected fluorescence signal can be readily differentiated from background signal caused by multiple scattering. The implementation permits simultaneous acquisition of confocal microscopy and focal modulation microscopy images. Advantages of focal modulation microscopy are demonstrated with a series of image experiments using a tissue phantom and cartilage tissues from chicken. An improved imaging penetration depth over conventional confocal microscopy systems may be achieved with focal modulation microscopy in accordance with embodiments of the invention, including a lower noise laser and a photodetector of lower dark current.

A fluorescence focal modulation microscopy system 10 in accordance with an embodiment of the invention is illustrated in FIG. 1. The system setup is similar to a confocal microscope, comprising an excitation light source 16, focusing assembly including objective lens 30, 2-dimensional scanning mirror 28, dichroic mirror 22, lens 20, aperture 24, photodetector 26, and a holder or stage 32 for holding the sample 40. The light source generates an excitation beam 34. A spatial phase modulator 18 is introduced into the excitation light path and the time-varying emission signal is retrieved for image forming. The excitation beam is generated by the light source, which can be for example a laser or a source of low temporal coherence or the like. The excitation beam 34, however, may have good spatial coherence and may be formed into a parallel beam. The spatial phase modulator can be either reflective or transmissive. The spatial modulator 18 may have a fast time response so that a high modulation frequency (f˜MHz) can be used. A personal computer 12 having a processor 38, memory 118, input 116, and data acquisition (DAQ) system 14 may process the signal detected on the detector to display an image of the sample on a display 114.

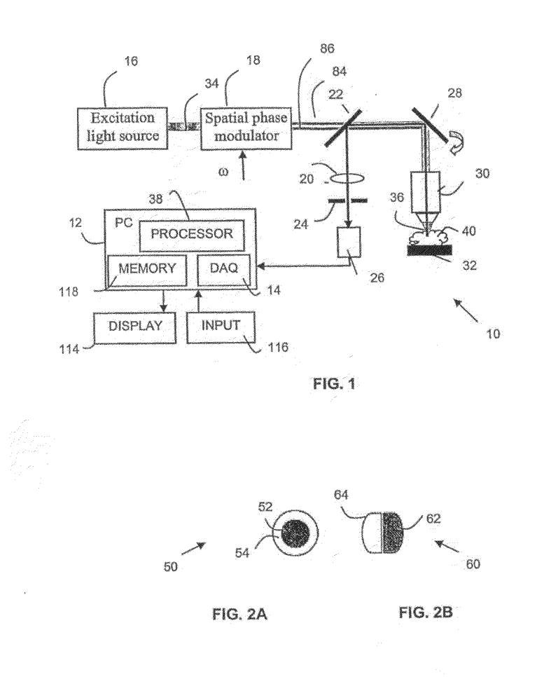

FIG. 2A-B show two examples of the phase modulator modulation pattern. In FIG. 2A, the aperture is split into two circular zones 50 of roughly the same area. The excitation beam 34 is separated into a center beam 52 and a peripheral beam 54 of identical intensity. The peripheral beam, passing through the clear zone, is subject to a constant phase delay. The phase of the center beam is modulated with a time-varying signal, for example, a harmonic signal of frequency (f), so that the phase difference between these two beams switches between 0 and π alternatively. In FIG. 2B, the aperture 60 is split into two half circles 62,64. Phase modulation is introduced to the shaded zone 52,62 only. In both cases, two parallel beams are formed with a time-varying phase difference. They pass through the dichroic mirror and are deflected by the 2D scanning mirror to an infinity corrected objective lens. Excitation light intensity around the focal point depends on the phase difference between two incident beams. When the two beams are in phase, they interfere with each other constructively and the intensity within the focal volume reaches the maximum. When the phase difference is π, the two beams interfere with each other destructively at the focal point and the optical power is directed to right outside the focal volume. The intensity undulation occurs at the same frequency for phase modulation and is confined to the region around the focal point. Distribution of the excitation light in other regions of a thick tissue sample remains constant. This is because that the ballistic components of the incident beams meet with each other only at the focal point. Multiply-scattered photons lose their coherence and do not generate any intensity fluctuation. The fluorescence emission 36 from the focal volume is collected by the same objective, descanned with the 2D scanning mirror, reflected by the dichroic mirror, focused by the lens, and pass through the pinhole before detected by the photodetector. Another optical filter can be inserted before the photodetector to further suppress excitation light. The aperture 24 may be a pinhole, and can be replaced with an optical fiber with a small core diameter. The pinhole, together with other optical components, defines a detection volume within the sample. The photodetector assembly 26 may comprise a detector array, such as for example a line CCD or the like. The photodetector assembly comprising such a detector array may be used together with a slit aperture or the like, or in another embodiment the detector array may act as the slit aperture itself. The photodetector assembly may comprise a photomultiplier (PMT) 102 for converting the luminescence signal detected by the photodetector to the photoelectrical signal having a DC component and an AC component. A strong AC component is present in the detected optoelectric signal when the detection volume matches, or is enclosed within, the focal volume. The amplitude of the AC signal is proportional to the concentration of fluorescent molecules in the detection volume only. This setup can also work without the pinhole. In that case the AC signal is related to differential changes in the fluorophore concentration around the focal point. The sample is scanned point-by-point just as in a conventional confocal microscope to obtain the 2D or 3D maps of the AC amplitude and/or phase, which are molecular specific images achievable by this microscope. FIG. 2A-2B show examples of the modulation pattern, however, it will be appreciated that other configurations of the phase modulator may be envisaged, for example, there may a larger gap between the two beams than shown in FIG. 2A-2B, the aperture may be a serrated aperture having a rough boundary, or the like.

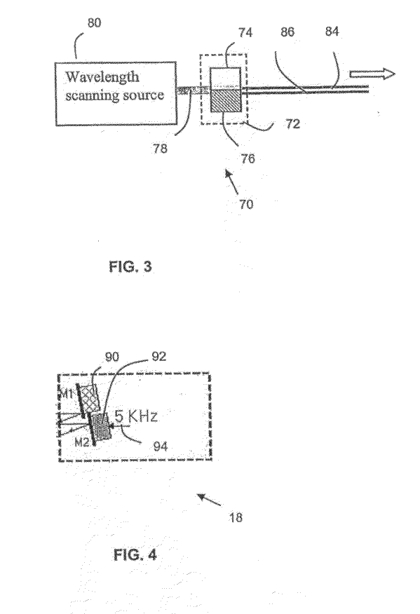

An alternative way to achieve spatial phase modulation is to use a wavelength scanning source 80, as shown in FIG. 3. The spatial phase modulator 70 with wavelength scanning source is shown, and the output beam 78 from the light source passes through a differential delay line 72, which results in two parallel beams with a certain, for example nonzero, difference in the optical pathlength. A first beam 74 is an unmodulated beam 84, and a second beam 76 is a modulated beam 86. When the wavelength of the light source is swept repeatedly, the phase difference between the two beams is modulated. Since the AC signal in the detected fluorescence emission comes from the focal volume only, the focal modulation technique is equivalent to selective excitation in multi-photon microscopy. Only a low power CW light source is needed in an embodiment of the system for one-photon excitation. However, in principle the technique can be combined with multi-photon excitation for an even greater imaging depth.

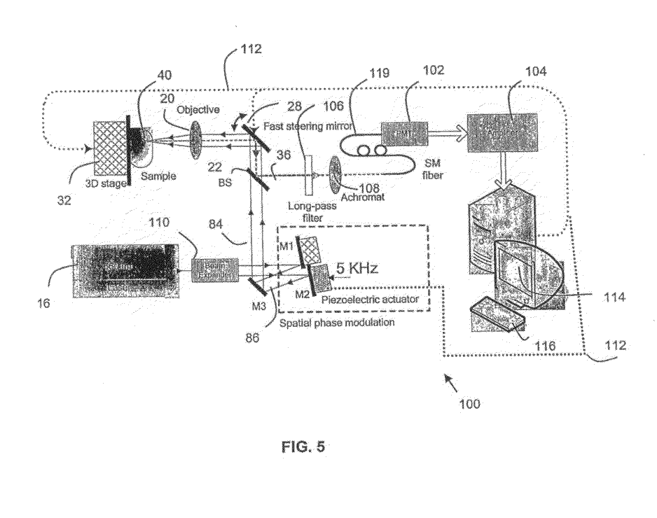

FIG. 5 shows another embodiment of the system. FIG. 5 is a schematic diagram of a prototype focal modulation microscopy system 100 in accordance with an embodiment of the invention. FIG. 5 shows a schematic diagram of the prototype focal modulation microscopy system. The spatial phase distribution of the 660 nm excitation beam 34 is modulated by the use of two parallel mirrors 90,92 (M1, M2, respectively). The system may have a beam expander 110. As shown in detail in FIG. 4, M1 is stationary relative to the beam and M2 is oscillating axially relative to M1. M2 may oscillate for example at 5 kHz. The fluorescence emission 36 from the focal volume is collected by a fiber based confocal detection system, and then the oscillatory component 94 at 5 kHz is retrieved for image formation. The personal computer 12 is interconnected 112 with the system and is used for data acquisition and analysis (DAQ) 14 with processor 38, lateral scanning with the fast steering mirror 28, and axial scanning with the 3D stage. It will be appreciated that the scanning assembly may be configured differently such that the holder or stage 32 holding the sample 40 may be scanned relative to the beam. Additionally, the spatial phase modulator 18 is shown arranged in the path of the light beam generated from the source, it will be appreciated that the spatial phase modulator 18 may also be configured at other positions along the path of the light beam and may be configured to be in the path of the luminescence emitted from the illuminated target region of the sample, for example between the dichroic mirror 22 or scanning mirror 28 and the objective lens 20. In an embodiment the modulator is placed so that the fluorescent light also passes through the modulator before being detected, for example, by placing the modulator between the beamsplitter and the scanning mirrors.

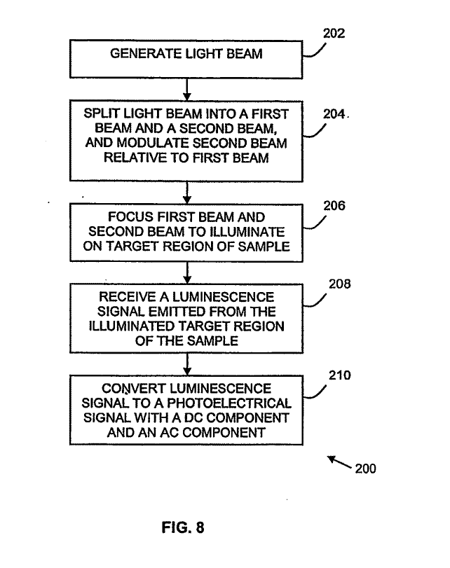

FIG. 8 shows a flow chart of a method 200 in accordance with an embodiment of the invention. The light beam is generated 202. The light beam is split 204 into a first beam and a second beam. The second beam is modulated relative the first beam, and the first and second beams are focused 206 to illuminate on a target region of sample. The detector receives 208 a luminescence signal emitted from the illuminated target region of the sample. The luminescence signal is converted 210 to a photoelectrical signal with a DC component and an AC component. Images of the photoelectrical signal may be processed by the processor 14,38 in the computer 12 and displayed on the display 114. The processor may process an image on the display 114 based on receiving the photoelectrical signal and calculating the maximum emission intensity from the sum of the AC amplitude of the AC component and the DC magnitude of the DC component. The processor may process an image on the display 114 based on receiving the photoelectrical signal and basing the image on the AC component of photoelectrical signal. Other components of the signal may be detected. For example, the phase of the ac signal may be detected, as in a lock-in amplifier that detects the in-phase and quadrature components of the signal.

As discussed, the focal modulation microscopy system is based on a confocal microscope. A spatial phase modulator 18 is inserted into the excitation light path. The light source is, for example, a 660 nm solid state laser whose 5 mW output beam is expanded from 1 mm to about 5 mm in diameter. Such a laser is for example NT57-968, Edmund Optics Inc. of Barrington, N.J., United States of America. When passing through the spatial phase modulator, the beam is split into two spatially separated half-beams, which are subject to different phase delays. In an embodiment, spatial phase modulation is implemented with two parallel mirrors (M1 and M2) inside the dashed box, each of which deflects half of the excitation beam to another mirror M3. M1 is mounted on a stationary base while M2 is mounted on a piezoelectric actuator. Such a piezoelectric actuator is for example AE0203D04 of Thorlabs Inc. of Newton, N.J., United States of America. The relative phase shift between the two half-beams is dependent on the voltage applied to the piezoelectric actuator. In the current configuration, a sinusoidal voltage signal of a single frequency f=5 kHz is superimposed on an appropriate DC bias to vary the relative phase shift periodically between 0 and π. The spatial phase modulated excitation beam, deflected by M3, passes through a 50/50 beam splitter (BS) or dichroic mirror and is directed by a 2-dimensional fast steering mirror to a 20× objective lens. The steering mirror may be for example FSM-300-01 from Newport Corporation of Irvine, Calif., United States of America, and the objective lens may be for example LUCPLFLN 20× from Olympus Inc. of Tokyo, Japan. Due to a varying spatial phase distribution, the excitation beam entering the objective aperture does not necessarily converge to the focal point. Consequently, an intensity modulation of the excitation light is achieved around the focal point. When the focal point is within a turbid medium, the excitation photons reaching the focal point include both ballistic, unscattered, and scattered photons. Only the ballistic photons contribute to an oscillatory excitation rate as they have well defined phase and polarization. Fluorescence emission, if any, is collected by the same objective and de-scanned is performed by the same fast steering mirror. A long pass filter 106 is used to reject the excitation light at 660 nm. The long pass filter may be for example 3RD670 LP from Omega Optical Inc. of Brattleboro, Vt., United States of America. Then the fluorescence light is focused with an achromat 108 and coupled into a single mode optic fiber 119, which may function as a detection pinhole. A photomultiplier tube (PMT) 102 converts the weak light signal convoyed by the optic fiber to an electrical signal, which is further enhanced by a 40 dB amplifier 104 before being digitized into a personal computer 12. The acquired photoelectrical signal contains a DC component, an AC component at 5 kHz due to modulated excitation, and random noise. A photomultiplier tube 116 may be for example R7400U-20, Hamamatsu Photonics Co. of Japan. A Fast Fourier Transform (FFT) is performed on the personal computer to retrieve both AC and DC signals. The sum of the AC amplitude and the DC magnitude is equal to the maximum emission intensity and thus equivalent to the conventional confocal microscopy signal. Focal modulation microscopy, however, uses the AC amplitude only for image formation. The personal computer 12 also controls the 2D fast steering mirror to scan the sample point-to-point to obtain both confocal microscopy and focal modulation microscopy images simultaneously.

### Imaging of Fluorescent Microspheres

Imaging was performed with a tissue phantom to characterize the optical sectioning capability of focal modulation microscopy in scattering media. Scarlet fluorescent polystyrene microspheres, for example FluoSpheres F8843 from Invitrogen Inc. of Carlsbad, Calif., United States of America, were distributed on the surface of a coverslip. The excitation/emission peaks of the microspheres are 645/680 nm, respectively. Direct imaging of the microspheres with a 20× objective, for example LUCFLFLN 20× from Olympus Inc., showed trivial differences between the confocal microscopy and focal modulation microscopy images in terms of lateral and axial resolutions. The fluorescent layer was then covered by a homogeneous scattering layer made of white glue. The scattering layer was about 100 microns in thickness, roughly equal to 2 Iₛ. The sample was mounted on a 3-axis motorized translation stage, for example T25XYZ/M from Thorlabs Inc., with a minimum incremental motion of 50 nm.

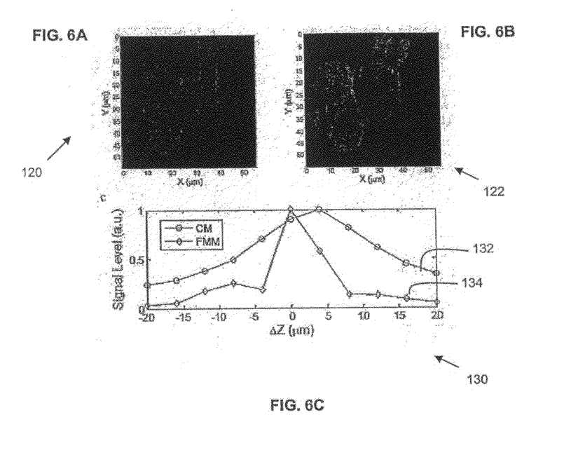

FIG. 6A shows a confocal microscopy image of microspheres acquired when the excitation beam is focused on the top surfaces of those smaller microspheres. The focal modulation microscopy image acquired in the same time is shown in FIG. 6B, which clearly reveals much more details on the surfaces. It is easy to see that a microsphere in the middle of the focal modulation microscopy image appears dark in the center and only its boundary is visible. The reason is that this microsphere was larger than others and its top surface was out-of-focus. On the contrary, the same microsphere looks intact and almost as bright as other ones in the confocal microscopy image. To further compare the optical sectioning capability, the sample was scanned axially by moving the translation stage at a 4 micron increment. In FIG. 6C the signal level, normalized to the peak value when the microspheres were in the focal plane, is plotted as a function of the defocus ΔZ. The focal modulation microscopy signal is confined within a FWHM (full width at half maximum) of around 7 microns, which is comparable with the depth of field of the objective (˜6.5 microns). The peak position of the confocal microscopy signal is slightly shifted backward, and the FWHM is increased to roughly 23 microns. An imaging depth of around 400 microns was achieved as shown in FIG. 6A-C. FIG. 6A-B show images of fluorescence microspheres covered by a scattering medium of 2 Iₛ in thickness. FIG. 6A shows a confocal microscopy image 120 of the fluorescent microspheres. FIG. 6B shows a focal modulation microscopy image 122 acquired simultaneously, showing high resolution details. FIG. 6C shows a graph 130 of confocal microscopy signal 132 and focal modulation microscopy signal 134 as a function of defocus. A much narrower axial profile of focal modulation microscopy indicates an optical sectioning capability not compromised by scattering.

### Imaging of Chondrocytes in Chicken Cartilage

To demonstrate the method for in vivo imaging of cellular and sub-cellular structure and function, chicken cartilage was a sample tissue to evaluate the performance of focal modulation microscopy. Chondrocytes are the only cells found in cartilage. The cells are usually of a rounded or bluntly angular form, lying in groups of two or more in a glandular or almost homogeneous matrix. A lipophilic fluorescent tracer is used to label the cell membrane so that only chondrocytes are visible in the fluorescence focal modulation microscopy and confocal microscopy images.

Chicken cartilage was cut into slices around 1 mm in thickness and labeled with DiR (DilC₁₈(7)), a lipophilic tracer with an emission, peak at 780 nm. The samples were scanned with the prototype focal modulation microscopy system at various depths ranging from 220 to 400 microns. The confocal microscopy image was acquired at a depth around 220 microns. The boundaries of individual cells are blurred and they all have a similar shape. In the corresponding focal modulation microscopy image, higher resolution and better contrast are evident. At the depth of 280 microns, the background signal appears even stronger in the confocal microscopy image. Cell outside the depth of focus cast shadows that cannot be differentiated from the cells in the focal plane. Again, the focal modulation microscopy image was acquired and showed uncompromised optical sectioning capability and spatial resolution, which are essential for accurate estimate of cell density, studies of cell morphology and site-specific binding efficiency of fluorescent dyes.

### Preparation of Tissue Sample

Fresh chicken wings were obtained and cartilage was cut into slices 1 mm in thickness. The cartilage slices were washed with PBS and then fixed with 4% paraformaldehyde for 24 hours at 4° C. The fixed tissues were immersed in 1 mM DiR (DilC₁₈(7), Invitrogen) stock solution in ethanol for over 24 hours at 4° C. to allow adequate staining of cells in the deep regions. The labeled samples were rinsed with PBS before being mounted on a glass slide with an antifading polyvinyl alcohol mounting medium, for example Product No. 10981 from Sigma-Aldrich of St. Louis, Mo., United States of America, and covered with a coverslip.

Focal modulation microscopy and confocal microscopy image acquisition, the samples were mounted on a 3-axis stage for accurate motorized positioning. Focal modulation microscopy and confocal microscopy image were acquired simultaneously with point-to-point scanning. The dwelling time on each pixel varied from 1 to 20 ms depending on the imaging depth and signal intensity. Each image consisted of 200 by 200 pixels with a 0.5 micron step size and was interpolated to 400 by 400 pixels. In imaging experiments with chicken cartilage, an additional emission filter, for example RG715 from Thorlabs Inc., was added to further reject the excitation light.

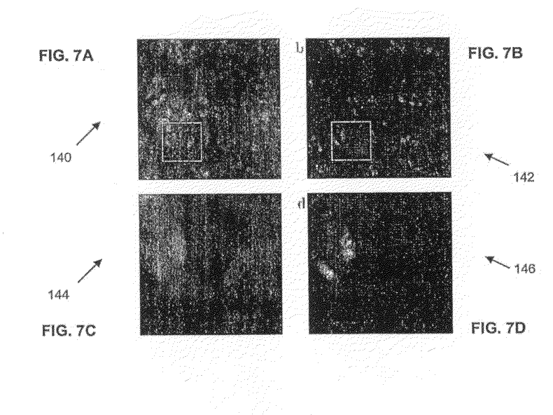

FIG. 7A-D show confocal modulation images 140 (FIG. 7A) and focal modulation microscopy 142 (FIG. 7B) images of chondrocytes obtained from chicken cartilage at a depth of 400 microns. Higher magnification view images 144,146 of the boxed regions in FIG. 7A-B are shown in FIG. 7C-D, respectively, with a scale bar of 20 microns. FIG. 7B shows a focal modulation microscopy image and FIG. 7A shows confocal microscopy image obtained from the depth of 400 microns. The cell density estimated from the focal modulation microscopy image FIG. 7B is similar to those in the shallower regions, while the confocal microscopy image FIG. 7A contains more cells from neighboring layers. A small region in the lower-left corner of the field of view is magnified and displayed in FIG. 7C-D for image qualities comparison.

Thus, a fluorescence focal modulation microscopy system and method is disclosed for high resolution molecular imaging of thick biological tissues with single photon excited fluorescence. Optical sectioning and diffraction limited spatial resolution are retained for imaging inside a multiple-scattering medium by the use of focal modulation, a technique for suppressing the background fluorescence signal excited by the scattered light. The focal modulation microscopy system has a spatial phase modulator 18 inserted in the excitation light path 34, which varies the spatial distribution of coherent excitation light around the focal volume periodically at a preset frequency. A fluorescence focal modulation image 122,142 is formed on a display 114 with the demodulated fluorescence, while a confocal image 120,140 is available simultaneously. Embodiments of the invention achieve a penetration depth comparable to optical coherence tomography and multi-photon microscopy. In accordance with embodiments of the invention the achieved imaging penetration depth is significantly greater than achievable with conventional confocal fluorescence microscopy. However, embodiments of the invention do not require a pulsed laser source for selective excitation. As described, embodiments of the invention use the coherence property of ballistic excitation light to selectively pick up the contribution from the focal volume only by the focal modulation technique. The excitation beam is manipulated to generate an intensity undulation around the focal point. The fluorescent emission from this area has an AC component of the same frequency, which is absent in the background signal. Since the origin of the AC signal is confined within a small volume defined by the ballistic excitation light, the resolution and contrast can be retained for a greater imaging depth than confocal microscopy. Embodiments are compatible with fluorescence and can work with the wide range of commercially available fluorescence dyes. In vivo imaging of cellular structure and functions in human subjects or animal models is made possible and affordable. There is a broad spectrum of applications for this new imaging technique.

It is to be understood that the embodiments, as described with respect to FIG. 1-8, are for exemplary purposes, as many variations of the specific hardware used to implement the disclosed exemplary embodiments are possible. For example, the functionality of the personal computer 12 of the embodiments and such variations may be implemented via one or more programmed computer system or devices to perform the functions of one or more of the devices and subsystems of the exemplary systems. The exemplary systems described with respect to FIG. 1-8 may be used to store information relating to various processes described herein. This information may be stored in one or more memories, such as hard disk, optical disk, magneto-optical disk, RAM, and the like, of the devices and sub-systems of the embodiments. One or more databases of the devices and subsystems may store the information used to implement the exemplary embodiments. The databases may be organized using data structures, such as records, tables, arrays, fields, graphs, trees, lists, and the like, included in one or more memories, such as the various memories. All or a portion of the exemplary systems described with respect to FIG. 1-8 may be conveniently implemented using one or more general-purpose computer systems, microprocessors, digital signal processors, micro-controllers, and the like, programmed according to the teachings of the disclosed exemplary embodiments. Appropriate software may be readily prepared by programmers of ordinary skill based on the teachings of the disclosed exemplary embodiments. In addition, the exemplary systems may be implemented by the preparation of application-specific integrated circuits or by interconnecting an appropriate network of component circuits.

While embodiments of the invention have been described and illustrated, it will be understood by those skilled in the technology concerned that many variations or modifications in details of design or construction may be made without departing from the present invention.

1. A fluorescence focal modulation microscopy system comprising:
a light source assembly for generating a light beam and illuminating a target region of a sample;
a spatial phase modulator arranged in the path of the light beam and splitting the light beam into a first beam and a second beam, the first beam being parallel and spatially separated from the second beam, the second beam modulated with different phase delay from the first beam;
a focusing assembly receiving the first beam and the second beam and illuminating the target region of the sample; and
a photodetector assembly for receiving a luminescence signal emitted from the illuminated target region of the sample, and converting the luminescence signal detected by the photodetector to a photoelectrical signal having a DC component and an AC component.

2. The system of claim 1, further comprising a processor and a display, the processor for processing an image on the display based on receiving the photoelectrical signal and calculating the maximum emission intensity from the sum of the AC amplitude and the DC magnitude.

3. The system of claim 1, further comprising a processor and a display, the processor for processing an image on the display based on receiving the photoelectrical signal and basing the image on the AC component of photoelectrical signal.

4. The system of claim 1, wherein the spatial phase modulator comprises a wavelength scanning source and a differential delay line.

5. The system of claim 4, wherein the wavelength scanning source is arranged to repeatedly sweep the wavelength of the light source with a predetermined difference in the optical path.

6. The system of claim 1, wherein spatial phase modulator comprises a first mirror and a second mirror, the second mirror moveable relative to the first mirror to modulate the second beam relative to the first beam.

7. The system of claim 6, wherein the second mirror is mounted on a piezoelectric actuator and the relative phase shift between the first and second beam is dependent on a voltage applied to the piezoelectric actuator.

8. The system of claim 1, wherein the focusing assembly comprises a dichroic mirror and an objective lens.

9. The system of claim 8, wherein the spatial phase modulator is arranged along in the path of the light beam upstream of the dichroic mirror.

10. The system of claim 8, wherein the spatial phase modulator is arranged along in the path of the light beam downstream of the dichroic mirror.

11. The system of claim 1, wherein the spatial phase modulator is arranged along the path of the light beam generated from the source and the path of the luminescence emitted from the illuminated target region of the sample.

12. The system of claim 1, further comprising a scanning assembly for scanning the first beam and second beam relative to the sample.

13. The system of claim 12, wherein the scanning assembly comprises a steering mirror for scanning the first beam and the second beam relative the sample.

14. The system of claim 12, wherein the scanning assembly comprises a holder for holding the sample and an actuator for moveable scanning the sample relative the first light beam and the second light beam.

15. The system of claim 1, further comprising an aperture in the path of the luminescence signal emitted from the illuminated target region of the sample to prevent luminescence emitted from non-target region of the sample to reach the photodetector.

16. The system of claim 15, wherein the aperture is selected from the group consisting of a pinhole, a slit, a long pass filter, or an optical fibre cable.

17. The system of claim 1, wherein the light source is arranged for one photon excitation.

18. The system of claim 1, wherein the light source is arranged for multi-photon excitation.

19. The system of claim 1, wherein the photodetector assembly further comprises a photomultiplier for converting the luminescence signal detected by the photodetector to the photoelectrical signal having a DC component and an AC component.

20. A method for performing fluorescence focal modulation microscopy comprising:
generating a light beam for illuminating a target region of a sample;
splitting the light beam with a spatial phase modulator arranged in the path of the light beam into a first beam and a second beam, the first beam being parallel and spatially separated from to the second beam, the second beam modulated with a different phase delay from the first beam;
focusing the first beam and second beam with a focusing assembly;
illuminating the target region of the sample with the first beam and the second beam;
receiving a luminescence signal emitted from the illuminated target region of the sample; and
converting the luminescence signal detected by the photodetector to a photoelectrical signal having a DC component and an AC component.

21. The method of claim 20, further comprising processing an image on a display based on receiving the photoelectrical signal and calculating the maximum emission intensity from the sum of the AC amplitude and the DC magnitude

22. The method of claim 20, further comprising processing an image on the display based on receiving the photoelectrical signal and basing the image on the AC component of photoelectrical signal.

23. The method of claim 20, wherein splitting of the light beam into a first beam and a second beam comprises repeatedly sweeping the wavelength of the light source with a predetermined difference in the optical path.

24. The method of claim 20, wherein splitting the light beam into a first beam and a second beam comprises the spatial phase modulator comprising a first mirror and a second mirror, and moving the second mirror relative to the first mirror to modulate the second beam relative to the first beam.

25. The method of claim 24, wherein the second mirror is mounted on a piezoelectric actuator and generating the relative phase shift between the first and second beam by applying a voltage to the piezoelectric actuator.

26. The method of claim 20, further comprising scanning the first beam and the second beam relative the sample.

27. The method of claim 20, further comprising preventing luminescence emitted from non-target region of the sample to reach the photodetector by placing an aperture in the path of the luminescence signal emitted from the illuminated target region of the sample.

28. The method of claim 20, wherein the spatial phase modulator for splitting the light beam is arranged along the path of the light beam generated from the source and the path of the luminescence emitted from the illuminated target region of the sample.
